(19) United States
(12) Patent Application Publication
(10) Pub. No.: US 2026/0093471 A1
(43) Pub. Date: Apr. 2, 2026

(54) DYNAMICAL SCHEDULING UPDATES FOR O-RAN COMPONENTS

(71) Applicant: Rakuten Symphony, Inc., Tokyo (JP)

(72) Inventors: Prasaanth GOWRAVALLI, Bangalore (IN); Yassar Sharaafath CHENNAMPILLIL AHAMADKUTTY, Bangalore (IN); Virendra REDDY, Bangalore (IN)

(21) Appl. No.: 18/902,803

(22) Filed: Sep. 30, 2024

(51) Int. Cl. G06F 8/65

(52) U.S. Cl. CPC G06F 8/65

(57) ABSTRACT

A system includes a non-transitory computer readable medium configured to store instructions thereon. The system further includes a processor connected to the non-transitory computer readable medium. The processor is configured to execute the instructions for establishing a NETCONF session. The processor is configured to execute the instructions for receiving a first instruction for a software update for a first NETCONF server, wherein the first instruction includes configuration information comprising schedule information. The processor is configured to execute the instructions for scheduling installation of the software update for the first NETCONF server based on the schedule information. The processor is configured to execute the instructions for and triggering, in response to the scheduling, a first installation cascade for the software update by the first NETCONF server based on the schedule information.

### TECHNICAL FIELD

The present disclosure relates to dynamic scheduling updates for O-RAN components.

### BACKGROUND

The information disclosed in this background section is only for enhancement of understanding of the general background of the disclosure and should not be taken as an acknowledgement or any form of suggestion that this information forms the prior art already known to a person skilled in the art.

Open Radio Access Network (O-RAN) is a technology that aims to create more open and interoperable cellular networks. O-RAN is an evolution of Radio Access Network (RAN) architecture. In some instances, O-RAN is controlled by a single operator.

The O-RAN architecture uses a distributed system of intelligent software agents, known as “white boxes,” to control the network. This allows for greater scalability and the ability to use a variety of different hardware components from different vendors.

O-RAN provides the ability to easily add new features and capabilities to the network by use of software-defined networking (SDN) and network functions virtualization (NFV) technologies.

O-RAN also helps to reduce costs for operators by allowing for the use of cheaper and more efficient hardware components. This helps to lower costs, which are potentially a barrier to the deployment of cellular networks.

Some elements of the O-RAN architecture include the Service Management and Orchestration Framework (SMO), RAN Intelligent Controller (RIC), O-Cloud, O-RAN central unit (O-CU or OCU), O-RAN distributed unit (O-DU or ODU), and O-RAN Radio unit (O-RU or ORU).

A control plane (C-plane) is responsible for signaling and control operations in the network by communicating with other network elements to coordinate and control various functions, such as call setup, mobility management and network resource allocation.

A user plane (U-plane) is responsible for delivering data and voice services to the end-users by transporting the actual user traffic between the radio access network and the core network.

A management plane (M-plane) provides centralized management and monitoring of the network elements, as well as configuration and maintenance of the network. The M-plane is responsible for monitoring the health and performance of the network, collecting statistics, and managing software upgrades and other network changes.

O-RAN provides a more secure network by separating the control plane and the data plane. This allows for greater flexibility in the deployment of security measures, such as firewalls, intrusion detection systems, and encryption.

### SUMMARY

A system for scheduling updates of a server, the system configured to establish a NETCONF session. The system is configured to receive a first instruction for a software update for a first NETCONF server. The first instruction includes configuration information comprising schedule information. The system is configured to schedule installation of the software update for the first NETCONF server based on the schedule information. The system is configured to trigger, in response to the scheduling, a first installation cascade for the software update by the first NETCONF server based on the schedule information.

A method includes establishing a NETCONF session. The method further includes receiving a first instruction for a software update for a first NETCONF server. The first instruction includes configuration information comprising schedule information. The method further includes scheduling installation of the software update for the first NETCONF server based on the schedule information. The method further includes and triggering, in response to the scheduling, a first installation cascade for the software update by the first NETCONF server based on the schedule information.

A non-transitory computer readable media having computer-readable instructions stored thereon, which in response to being executed causes a system to updates of a server to perform operations including establishing a NETCONF session. The operations further including receiving a first instruction for a software update for a first NETCONF server. The first instruction includes configuration information including schedule information. The operations further including scheduling installation of the software update for the first NETCONF server based on the schedule information. The operations further including triggering, in response to the scheduling, a first installation cascade for the software update by the first NETCONF server based on the schedule information.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic diagram of example components of an O-RAN system, according to at least some embodiments of the subject disclosure.

FIG. 2 is a block diagram of example components of an O-RAN system illustrating a NETCONF client and NETCONF server interaction and/or relationship, according to some embodiments of the subject disclosure.

FIG. 3 is a sequence diagram of example components of a method of scheduling a software update for a first NETCONF server from a first NETCONF client, in accordance with some embodiments.

FIG. 4 is a flowchart of example components of a method of assigning a schedule for software updates for a set of NETCONF servers, in accordance with some embodiments.

FIG. 5 is a flowchart of example components of a method of deploying a schedule for software updates for a set of NETCONF servers, in accordance with some embodiments.

FIG. 6 is a sequence diagram of example components of an installation process using a schedule, in accordance with some embodiments.

FIG. 7 is a flowchart of example components of a method of canceling software updates for a set of NETCONF servers, in accordance with some embodiments.

FIG. 8 is a sequence diagram of example components of an installation cancellation process, in accordance with some embodiments.

FIG. 9 is a block diagram of example components of computer architecture in accordance with some embodiments.

FIG. 10 a block diagram of example components of an alternative computer architecture in accordance with some embodiments.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

There are several instances wherein technological evolution creates inconsistencies or incompatibilities between previous capabilities and newly introduced capabilities or arising needs. In some instances, technologies become stale, outdated or become unable to provide support for newly introduced capabilities. In some instances, technologies are built with specific parameters or limitations that are unable to accommodate growth or unanticipated introduction of technology features.

In some instances, telecommunications, wireless, or cellular technology becomes outdated due to the rapid evolution or use of technology in the wireless or cellular technology area. As a result, rapid adaptability and new solutions are needed to accommodate rapidly changing broadband cellular network technology.

In some instances, a shift in technological capabilities or features is observable between fourth generation (4G)/Long-Term Evolution (LTE™) and fifth generation (5G) broadband cellular network technology. LTE™ sought to increase the capacity and speed of wireless data networks using new DSP (digital signal processing) techniques and modulations that previously were developed, and to redesign and simplify the network architecture to an internet protocol (IP) based system with reduced transfer latency, compared with the third generation (3G) broadband cellular network technology. Yet not only are 5G networks even faster than predecessor 4G networks, 5G possesses higher bandwidth and is able to connect a larger number of different devices, improving quality of internet services.

In some instances, technologies become stale, outdated or become unable to provide support for newly introduced capabilities or arising needs is observable in a lack of more granular features to calibrate or fine-tune software deployment.

In some more specific instances, O-RAN specifications partially or entirely lack support for newly arising needs to schedule software downloads, software installation and reset operations from O-RU controllers. That is, a technological mismatch or deficiency in accommodating new technology or arising needs has occurred.

In order to help reduce or solve these problems associated with technological evolution or shifts described, the current description includes systems and methods that accommodate or allow for scheduling software downloads and software installation and provide reset operations from O-RU controllers. The current description includes systems and methods that allow for more appropriate or more efficient software deployments. As a result, the current description includes systems and methods that are able to address deficiencies associated with technological mismatches or outdated architecture.

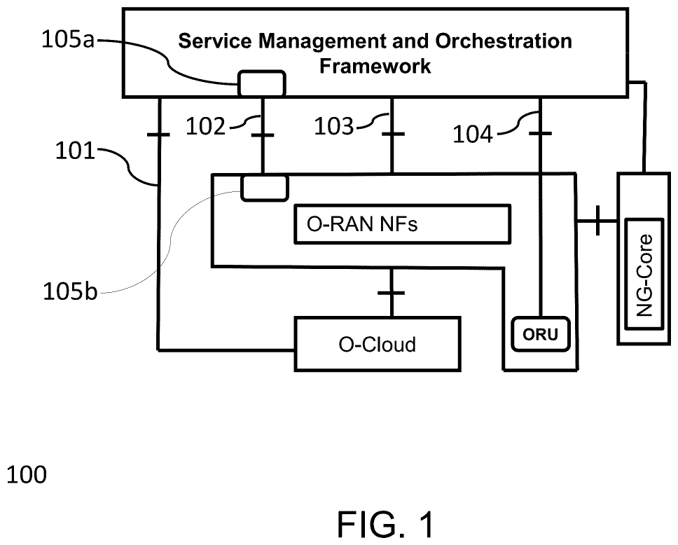

FIG. 1 is a schematic diagram of an O-RAN system 100, according to at least some embodiments of the subject disclosure.

O-RAN system 100 includes four interfaces A1 (102), O1 (103), Open Fronthaul M-plane interface (104) and O2 (101) that connect SMO (Service Management and Orchestration) 105 framework to O-RAN network functions and O-Cloud 106, a cloud computing platform comprising a collection of physical infrastructure nodes meeting O-RAN requirements to host relevant O-RAN functions. In some cases, O-RAN Network Functions 107 are VNFs (Virtualized Network Function) and/or PNFs (Physical Network Function) utilizing customized hardware Non-Real-Time RAN Intelligent Controller (Non-RT RIC) is shown at 107a,, and Near-Real-Time RAN Intelligent Controller (Near-RT RIC) is shown at 107b. Near-RT RIC 107a is a logical function that enables near-real-time control and optimization of RAN elements and resources via fine-grained data collection and actions. Non-RT RIC 107b is a logical function within SMO 105 that drives the content carried across the A1 interface 102. Open Fronthaul M-plane interface (104) interfaces SMO 105 and O-RU 108. Mobile Core 109 is a bundle of functionality for authenticating devices, providing Internet (IP) connectivity, tracking user mobility, tracking subscriber usage, etc.

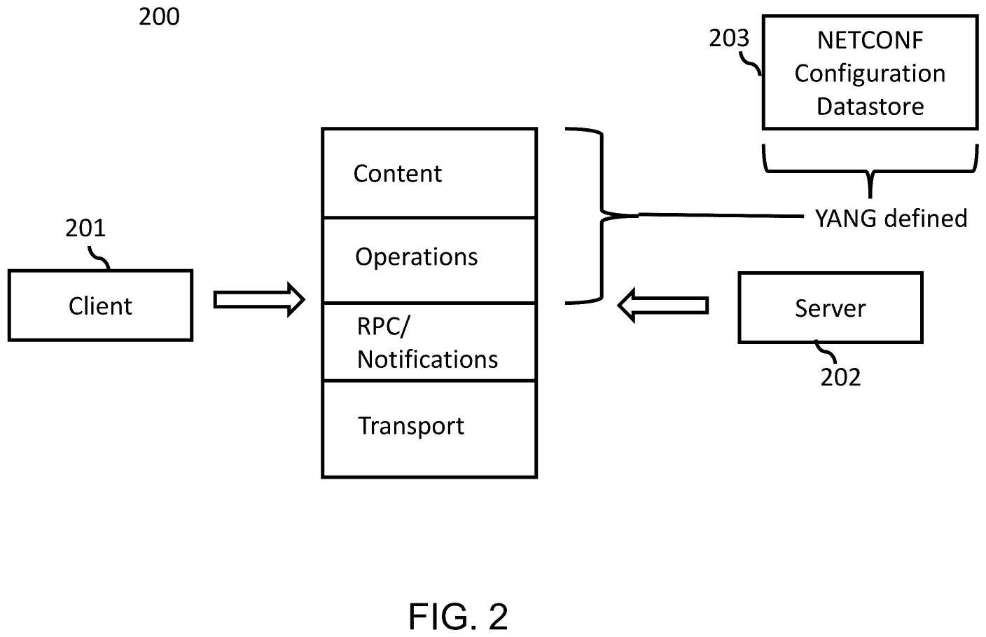

FIG. 2 is a block diagram of an O-RAN system 200 illustrating a NETCONF client 201 and NETCONF server 202 interaction and/or relationship, according to some embodiments of the subject disclosure.

The O1 interface provides support for the NETCONF protocol, which is usable to configure and manage network elements such as Near RT-RIC, O-CU, O-DU, and O-RU. A NETCONF client 201 is configured to use data models to drive configuration and management of such network elements as RIC, CU, DU, and RU, each of which is a NETCONF server 202. As shown, NETCONF configuration datastore 203 is YANG-defined, in some embodiments. Content 204a, operations 204b, remote procedure call (RPC)/notification 204c, and transport 204d elements used in client-server interactions are shown.

In some embodiments, a shared resource owner or operator is a tenant operator or owner, such as an O-DU/O-CU operator, where an owner implements an O-CU and O-DU connected to a shared O-RU.

In at least one example, the owner/operator includes a client, such NETCONF client 201, a shared resource configuration information, or common resource data.

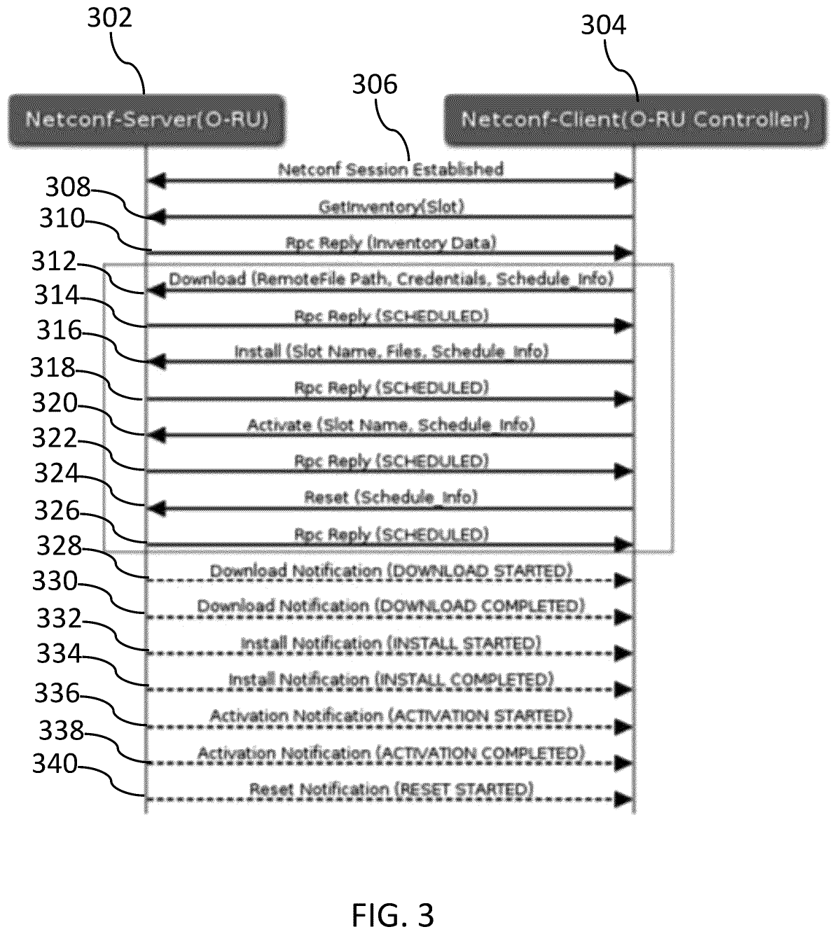

FIG. 3 is a sequence diagram of a method 300 of scheduling a software update for a first NETCONF server 302 from a first NETCONF client 304, in accordance with some embodiments. The method 300 is usable by an O-RAN system in order to help ensure that software deployment is more efficiently distributed to system components. By utilizing a scheduling process, the method 300 helps to ensure that the software is more safely distributed to available system components. In some embodiments, the method 300 is able to be executed by the O-RAN system 100 (FIG. 1) or the O-RAN system 200 (FIG. 2). In some embodiments, the method 300 is able to be executed by an O-RAN system other than the O-RAN system 100 (FIG. 1) or the O-RAN system 200 (FIG. 2).

In operation 306, a NETCONF session is established between the first NETCONF server 302 and the first NETCONF client 304. The first NETCONF server 302 is an O-RU. The first NETCONF client 304 is an O-RU controller. In some embodiments, for a NETCONF server and a NETCONF client connected and/or in communication, a secure Transport Layer Security/Secure Shell Protocol (TLS/SSH) session is established. In some embodiments, during an O-RU startup procedure, an M-Plane connection between an O-RU and NETCONF client is established, and an exchange of Transport Layer address information is carried out, including manual setting of Transport Layer addresses, allocation of Transport Layer addresses by a Dynamic Host Configuration Protocol (DHCP) server, and/or allocation of Transport Layer addresses by stateless address auto-configuration. In some embodiments, management of O-RUs occurs in the M-plane. For example, in M-plane, the O-DU and/or Network Management Service (NMS) manages O-RUs. In some embodiments, a hierarchical model or a hybrid model are used as a configuration model for O-RU management.

### Hierarchical Model

In a hierarchical model configuration, O-RUs are managed by a respective O-DUs.

### Hybrid Model

In a hybrid model configuration, O-RUs are managed by one or NMSs and/or respective O-DUs.

In some embodiments, a hierarchical configuration model is used. In some embodiments, a hybrid configuration model is used.

In some embodiments, all or multiple NETCONF servers support multiple NETCONF sessions, and all or multiple O-RUs support both hierarchical and hybrid model deployment. In some embodiments, a software management function includes operations to allow a software update, package, or build to be downloaded, installed in a particular slot, and for a slot to be activated at an O-RU. In some embodiments, a software package, such as a zip file, is downloaded to an O-RU. In some embodiments, files that are part of a software build are downloaded to an O-RU. In some embodiments, a reset RPC is used to trigger operation of activated software at an O-RU.

In some embodiments, O-RU controllers or NETCONF clients are configured to subscribe to YANG notifications from an O-RU or NETCONF server.

In operation 308, a software inventory is fetched by NETCONF client 304 from NETCONF server 302 using a NETCONF “get” RPC filtered over a “software-slot” container. In some embodiments, the RPC is a function call, message, command, or request. In some embodiments, one or more O-RUs are running software from a slot with an “active” variable, setting, or option equal to “True” or “1.” In some embodiments, one or more O-RUs mark a slot with currently used software with a “running” variable, setting, or option equal to “True” or “1.”

In operation 310, an RPC reply containing inventory data is delivered from NETCONF server 302 to NETCONF client 304. In some embodiments, the RPC reply is delivered from NETCONF server 302 to NETCONF client 304 immediately or substantially immediately after operation 312. In some embodiments, the RPC contains information about each software slot of the NETCONF server 302 O-RU and the contents of each slot. For example, an “active” variable or state of “True” is returned for an O-RU when software stored in the respective slot is activated at the moment. In some embodiments, the RPC is a function call, message, command, or request.

In operation 312, a software-download RPC including remote-file-path, credentials, and schedule information is delivered from NETCONF client 304 to NETCONF server 302 to trigger download of software to NETCONF server 302. In some embodiments, a software download is performed using a Secure File Transfer Protocol (sFTP) or File Transfer Protocol-Secure/Explicit (FTPES). In some embodiments, the software-download RPC includes either a path to a file in a build or path to a software package file as input. In some embodiments, the software-download RPC includes a URI of a remote location where software files are stored. In some embodiments, the URI specifies use of sFTP or FTPES. In some embodiments, NETCONF client 304 will only trigger a software-download RPC specifying FTPES if NTCONF/TLC is used to configure the NETCONF server 304 O-RU. In some embodiments, the software-download RPC includes a password (string). In some embodiments, the software-download RPC includes keys. In some embodiments, the software-download RPC includes one or more certificates. In some embodiments, the software-download RPC includes schedule information. In some embodiments, an established M-Plane NETCONF session is a pre-condition for triggering a software-download RPC, message, or request.

In some embodiments, schedule information includes a start date. In some embodiments, schedule information includes a start time. In some embodiments, schedule information includes a YANG start date. In some embodiments, schedule information includes a YANG start time. In some embodiments, schedule information is Read Only.

In operation 314, an RPC reply containing a confirmation that a download process is scheduled is delivered from NETCONF server 302 to NETCONF client 304. In some embodiments, the RPC reply is delivered from NETCONF server 302 to NETCONF client 304 immediately or substantially immediately after operation 312. In some embodiments, the RPC has a status of “STARTED.” In some embodiments, the RPC has a status of “FAILED.” In some embodiments, the RPC has a status of “SCHEDULED.” In some embodiments, NETCONF client 304 waits for the RPC reply previously described in operation 314. In some embodiments, NETCONF client 304 waits for the RPC reply previously described before proceeding to operation 316. In some embodiments, NETCONF client 304 waits for the RPC reply previously described including a status of “STARTED” in operation 314. In some embodiments, NETCONF client 304 waits for the RPC reply previously described including a status of “STARTED” before proceeding to operation 316. In some embodiments, NETCONF server 302 waits for the RPC reply previously described including a status of “SCHEDULED” in operation 314. In some embodiments, NETCONF client 304 waits for the RPC reply previously described including a status of “SCHEDULED” before proceeding to operation 316.

In operation 316, a software-install RPC including file-names, slot-name, and schedule information is delivered from NETCONF client 304 to NETCONF server 302 to trigger installation of software at NETCONF server 302 that was downloaded or scheduled to be downloaded in operation 314. In some embodiments, an established M-Plane NETCONF session is a pre-condition for triggering a software-install RPC, message, or request. In some embodiments, the RPC is a function call, message, command, or request. In some embodiments, the slot specified by the slot-name has an “active” status or variable set to “False” and a “running” status or variable set to “False.”

In some embodiments, schedule information includes a start date. In some embodiments, schedule information includes a start time. In some embodiments, schedule information includes a YANG start date. In some embodiments, schedule information includes a YANG start time. In some embodiments, schedule information is Read Only.

In operation 318, an RPC reply containing a confirmation that an install process is scheduled is delivered from NETCONF server 302 to NETCONF client 304. In some embodiments, the RPC reply is delivered from NETCONF server 302 to NETCONF client 304 immediately or substantially immediately after operation 316. In some embodiments, the RPC has a status of “STARTED.” In some embodiments, the RPC has a status of “FAILED.” In some embodiments, the RPC has a status of “SCHEDULED.” In some embodiments, NETCONF client 304 waits for the RPC reply previously described in operation 318. In some embodiments, NETCONF client 304 waits for the RPC reply previously described before proceeding to operation 320. In some embodiments, NETCONF client 304 waits for the RPC reply previously described including a status of “STARTED” in operation 318. In some embodiments, NETCONF client 304 waits for the RPC reply previously described including a status of “STARTED” before proceeding to operation 320. In some embodiments, NETCONF server 302 waits for the RPC reply previously described including a status of “SCHEDULED” in operation 318. In some embodiments, NETCONF client 304 waits for the RPC reply previously described including a status of “SCHEDULED” before proceeding to operation 320.

In operation 320, a software-activate RPC including slot-name and schedule information is delivered from NETCONF client 304 to NETCONF server 302 to trigger activation of software at NETCONF server 302 that was downloaded or scheduled to be downloaded in operation 314. In some embodiments, an established M-Plane NETCONF session is a pre-condition for triggering a software-activate RPC, message, or request. In some embodiments, the RPC is a function call, message, command, or request. In some embodiments, the slot specified by the slot-name has an “status” variable set to “Valid.”

In some embodiments, schedule information includes a start date. In some embodiments, schedule information includes a start time. In some embodiments, schedule information includes a YANG start date. In some embodiments, schedule information includes a YANG start time. In some embodiments, schedule information is Read Only.

In operation 322, an RPC reply containing a confirmation that an activation process is scheduled is delivered from NETCONF server 302 to NETCONF client 304. In some embodiments, the RPC reply is delivered from NETCONF server 302 to NETCONF client 304 immediately or substantially immediately after operation 320. In some embodiments, the RPC has a status of “STARTED.” In some embodiments, the RPC has a status of “FAILED.” In some embodiments, the RPC has a status of “SCHEDULED.” In some embodiments, NETCONF client 304 waits for the RPC reply previously described in operation 322. In some embodiments, NETCONF client 304 waits for the RPC reply previously described before proceeding to operation 324. In some embodiments, NETCONF client 304 waits for the RPC reply previously described including a status of “STARTED” in operation 322. In some embodiments, NETCONF client 304 waits for the RPC reply previously described including a status of “STARTED” before proceeding to operation 324. In some embodiments, NETCONF server 302 waits for the RPC reply previously described including a status of “SCHEDULED” in operation 322. In some embodiments, NETCONF client 304 waits for the RPC reply previously described including a status of “SCHEDULED” before proceeding to operation 324.

In operation 340, a reset RPC including schedule information is delivered from NETCONF client 304 to NETCONF server 302 to trigger a reset of NETCONF server 302. In some embodiments, an established M-Plane NETCONF session is a pre-condition for triggering a reset RPC, message, or request. In some embodiments, the RPC is a function call, message, command, or request.

In some embodiments, schedule information includes a start date. In some embodiments, schedule information includes a start time. In some embodiments, schedule information includes a YANG start date. In some embodiments, schedule information includes a YANG start time. In some embodiments, schedule information is Read Only.

In operation 326, an RPC reply containing a confirmation that a reset process is scheduled is delivered from NETCONF server 302 to NETCONF client 304. In some embodiments, the RPC reply is delivered from NETCONF server 302 to NETCONF client 304 immediately or substantially immediately after operation 324. In some embodiments, the RPC has a status of “OK.” In some embodiments, the RPC has a status of “FAILED.” In some embodiments, the RPC has a status of “SCHEDULED.” In some embodiments, NETCONF client 304 waits for the RPC reply previously described in operation 326. In some embodiments, NETCONF client 304 waits for the RPC reply previously described before proceeding to operation 328. In some embodiments, NETCONF client 304 waits for the RPC reply previously described including a status of “OK” in operation 326. In some embodiments, NETCONF client 304 waits for the RPC reply previously described including a status of “OK” before proceeding to operation 328. In some embodiments, NETCONF server 302 waits for the RPC reply previously described including a status of “SCHEDULED” in operation 326. In some embodiments, NETCONF client 304 waits for the RPC reply previously described including a status of “SCHEDULED” before proceeding to operation 328.

In operation 328, a “STARTED” download-event notification is delivered from NETCONF server 302 to NETCONF client 304. In some embodiments, the download-event is delivered from NETCONF server 302 to NETCONF client 304 immediately or substantially immediately after operation 312. In some embodiments, the download-event is delivered from NETCONF server 302 to NETCONF client 304 immediately or substantially immediately after operation 326. In some embodiments, the download-event is delivered from NETCONF server 302 to NETCONF client 304 immediately or substantially immediately after a download event occurs. In some embodiments, the download-event has a status of “STARTED.” In some embodiments, the download-event has a status of “COMPLETED.” In some embodiments, the download-event has a status of “FAILED.” In some embodiments, NETCONF client 304 waits for the download-event previously described in operation 328. In some embodiments, NETCONF client 304 waits for the download-event previously described before proceeding to operation 316. In some embodiments, NETCONF client 304 waits for the download-event previously described before proceeding to operation 330. In some embodiments, NETCONF client 304 waits for the download-event previously described including a status of “STARTED” in operation 328. In some embodiments, NETCONF client 304 waits for the download-event previously described including a status of “STARTED” before proceeding to operation 316.

In operation 330, a “COMPLETED” download-event notification is delivered from NETCONF server 302 to NETCONF client 304. In some embodiments, the download-event is delivered from NETCONF server 302 to NETCONF client 304 immediately or substantially immediately after operation 312. In some embodiments, the download-event is delivered from NETCONF server 302 to NETCONF client 304 immediately or substantially immediately after operation 326. In some embodiments, the download-event is delivered from NETCONF server 302 to NETCONF client 304 immediately or substantially immediately after a download event occurs. In some embodiments, the download-event has a status of “STARTED.” In some embodiments, the download-event has a status of “COMPLETED.” In some embodiments, the download-event has a status of “FAILED.” In some embodiments, NETCONF client 304 waits for the download-event previously described in operation 330. In some embodiments, NETCONF client 304 waits for the download-event previously described before proceeding to operation 316. In some embodiments, NETCONF client 304 waits for the download-event previously described before proceeding to operation 332. In some embodiments, NETCONF client 304 waits for the download-event previously described including a status of “COMPLETED” in operation 330. In some embodiments, NETCONF client 304 waits for the download-event previously described including a status of “COMPLETED” before proceeding to operation 316.

In operation 332, a “STARTED” install-event notification is delivered from NETCONF server 302 to NETCONF client 304. In some embodiments, the install-event is delivered from NETCONF server 302 to NETCONF client 304 immediately or substantially immediately after operation 316. In some embodiments, the install-event is delivered from NETCONF server 302 to NETCONF client 304 immediately or substantially immediately after operation 330. In some embodiments, the install-event is delivered from NETCONF server 302 to NETCONF client 304 immediately or substantially immediately after an install event occurs. In some embodiments, the install-event has a status of “STARTED.” In some embodiments, the install-event has a status of “COMPLETED.” In some embodiments, the install-event has a status of “FAILED.” In some embodiments, NETCONF client 304 waits for the install-event previously described in operation 328. In some embodiments, NETCONF client 304 waits for the install-event previously described before proceeding to operation 320. In some embodiments, NETCONF client 304 waits for the install-event previously described before proceeding to operation 334. In some embodiments, NETCONF client 304 waits for the install-event previously described including a status of “STARTED” in operation 332. In some embodiments, NETCONF client 304 waits for the install-event previously described including a status of “STARTED” before proceeding to operation 320.

In operation 334, a “COMPLETED” install-event notification is delivered from NETCONF server 302 to NETCONF client 304. In some embodiments, the install-event is delivered from NETCONF server 302 to NETCONF client 304 immediately or substantially immediately after operation 316. In some embodiments, the install-event is delivered from NETCONF server 302 to NETCONF client 304 immediately or substantially immediately after operation 332. In some embodiments, the install-event is delivered from NETCONF server 302 to NETCONF client 304 immediately or substantially immediately after an install event occurs. In some embodiments, the install-event has a status of “STARTED.” In some embodiments, the install-event has a status of “COMPLETED.” In some embodiments, the install-event has a status of “FAILED.” In some embodiments, NETCONF client 304 waits for the install-event previously described in operation 334. In some embodiments, NETCONF client 304 waits for the install-event previously described before proceeding to operation 320. In some embodiments, NETCONF client 304 waits for the install-event previously described before proceeding to operation 336. In some embodiments, NETCONF client 304 waits for the install-event previously described including a status of “COMPLETED” in operation 334. In some embodiments, NETCONF client 304 waits for the install-event previously described including a status of “COMPLETED” before proceeding to operation 320.

In operation 336, a “STARTED” activation-event notification is delivered from NETCONF server 302 to NETCONF client 304. In some embodiments, the activation-event is delivered from NETCONF server 302 to NETCONF client 304 immediately or substantially immediately after operation 320. In some embodiments, the activation-event is delivered from NETCONF server 302 to NETCONF client 304 immediately or substantially immediately after operation 334. In some embodiments, the activation-event is delivered from NETCONF server 302 to NETCONF client 304 immediately or substantially immediately after an activate event occurs. In some embodiments, the activation-event has a status of “STARTED.” In some embodiments, the activation-event has a status of “COMPLETED.” In some embodiments, the activation-event has a status of “FAILED.” In some embodiments, NETCONF client 304 waits for the activation-event previously described in operation 336. In some embodiments, NETCONF client 304 waits for the activation-event previously described before proceeding to operation 324. In some embodiments, NETCONF client 304 waits for the activation-event previously described before proceeding to operation 340. In some embodiments, NETCONF client 304 waits for the activation-event previously described including a status of “STARTED” in operation 336. In some embodiments, NETCONF client 304 waits for the activation-event previously described including a status of “STARTED” before proceeding to operation 324.

In operation 338, a “COMPLETED” activation-event notification is delivered from NETCONF server 302 to NETCONF client 304. In some embodiments, the activation-event is delivered from NETCONF server 302 to NETCONF client 304 immediately or substantially immediately after operation 320. In some embodiments, the activation-event is delivered from NETCONF server 302 to NETCONF client 304 immediately or substantially immediately after operation 336. In some embodiments, the activation-event is delivered from NETCONF server 302 to NETCONF client 304 immediately or substantially immediately after an activate event occurs. In some embodiments, the activation-event has a status of “STARTED.” In some embodiments, the activation-event has a status of “COMPLETED.” In some embodiments, the activation-event has a status of “FAILED.” In some embodiments, NETCONF client 304 waits for the activation-event previously described in operation 338. In some embodiments, NETCONF client 304 waits for the activation-event previously described before proceeding to operation 324. In some embodiments, NETCONF client 304 waits for the activation-event previously described before proceeding to operation 340. In some embodiments, NETCONF client 304 waits for the activation-event previously described including a status of “COMPLETED” in operation 338. In some embodiments, NETCONF client 304 waits for the activation-event previously described including a status of “COMPLETED” before proceeding to operation 324.

In operation 340, a “STARTED” reset-event notification is delivered from NETCONF server 302 to NETCONF client 304. In some embodiments, the reset-event is delivered from NETCONF server 302 to NETCONF client 304 immediately or substantially immediately after operation 322. In some embodiments, the reset-event is delivered from NETCONF server 302 to NETCONF client 304 immediately or substantially immediately after operation 338. In some embodiments, the reset-event is delivered from NETCONF server 302 to NETCONF client 304 immediately or substantially immediately after a reset event occurs. In some embodiments, the reset-event has a status of “STARTED.” In some embodiments, the activation-event has a status of “COMPLETED.” In some embodiments, the activation-event has a status of “FAILED.” In some embodiments, NETCONF client 304 waits for the reset-event previously described in operation 340. In some embodiments, NETCONF client 304 waits for the reset-event previously described including a status of “STARTED” in operation 340. In some embodiments, NETCONF client 304 waits for the reset-event previously described including a status of “STARTED”before proceeding.

One of ordinary skill in the art would understand that additional operations are possible within method 300 in some embodiments. In some embodiments, an order of operations of the method 300 is changed. In some embodiments, at least one operation of the method 300 is omitted.

Utilizing the method 300 helps to efficiently utilize network resources. As a result, the network is more likely to function as intended following software deployment into the network in comparison with other approaches that fail to provide scheduling methods.

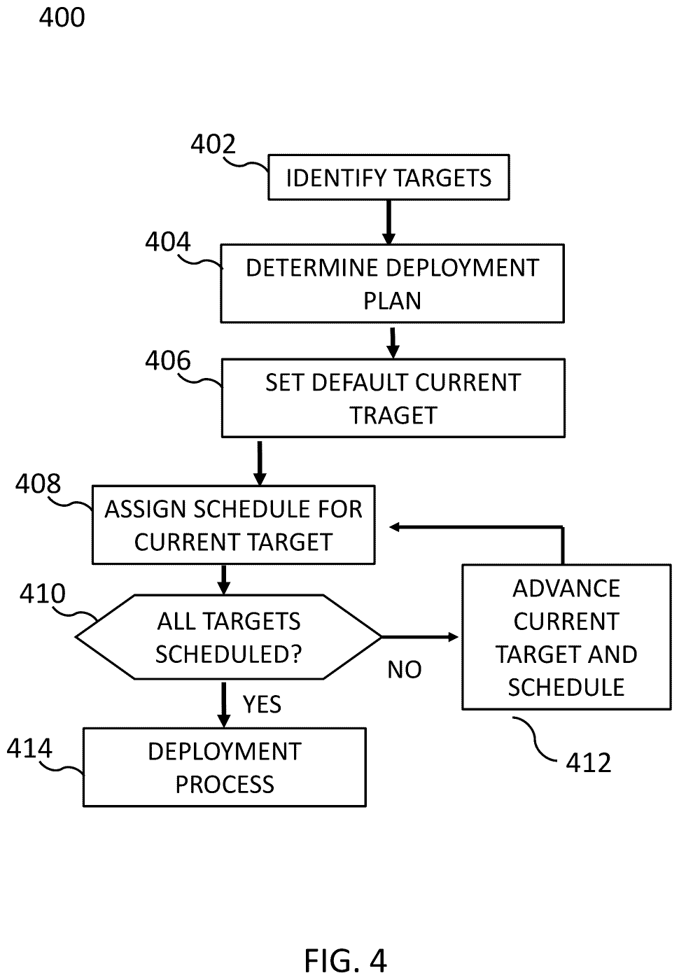

FIG. 4 is a flowchart of a method 400 of assigning a schedule for software updates for a set of NETCONF servers, in accordance with some embodiments. The method 400 is usable by an O-RAN system in order to help ensure that software deployment is more efficiently distributed to system components. By utilizing a assigning process, the method 400 helps to ensure that the software is more safely distributed to available system components. In some embodiments, the method 400 is able to be executed by the O-RAN system 100 (FIG. 1) or the O-RAN system 200 (FIG. 2). In some embodiments, the method 400 is able to be executed by an O-RAN system other than the O-RAN system 100 (FIG. 1) or the O-RAN system 200 (FIG. 2).

In operation 402, a set of targets is identified. In some embodiments, each target is a NETCONF server. In some embodiments, each target is an O-RU. In some embodiments, each target is to receive a software update or upgrade.

In operation 404, a deployment plan is determined. In some embodiments, a deployment plan is pre-configured. In some embodiments, a deployment plan is created, identified, or determined programmatically. In some embodiments, a deployment plan determines, creates, or specifies a schedule for which software will be deployed to a set of targets. In some embodiments, a deployment plan includes a time and date for a software installation. In some embodiments, a deployment plan includes multiple times and dates at which each of a set of targets will receive a software update. In some embodiments, a deployment plan includes a set of staggered times and dates. For example, a deployment plan includes a set of times and dates that are each two milliseconds apart.

In operation 406, a default current target is identified. In some embodiments, a default current target is a first target in a set of targets.

In operation 408, a scheduled date and time from the deployment plan is assigned to the current target. For example, a first target is assigned the first date and time in a deployment plan.

In operation 410, a determination is made whether all targets in a set of targets have been assigned a date and time according to the deployment plan. In some embodiments, if targets remain in the set of targets that have not yet been assigned a date and time from the deployment plan, operation 412 is executed. In some embodiments, if all targets in the set of targets have been scheduled to receive the software update according to the deployment plan, a deployment process is started in operation 414.

In operation 412, the current target and deployment schedule date and time is advanced to a next target and next date and time. For example, a second target in a set of targets is selected as the current target after a first target. Further, for example, a second date and time is selected according to the deployment plan. In an example where each date and time are staggered by two milliseconds, a date and time that is two milliseconds after a first date and time assigned and scheduled to the first target is selected. In some embodiments, operation 408 is repeated using the next target and next date and time determined in operation 412.

One of ordinary skill in the art would understand that additional operations are possible within method 400 in some embodiments. In some embodiments, an order of operations of the method 400 is changed. In some embodiments, at least one operation of the method 400 is omitted.

Utilizing the method 400 helps to efficiently utilize network resources. As a result, the network is more likely to function as intended following software deployment into the network in comparison with other approaches that fail to provide scheduling methods.

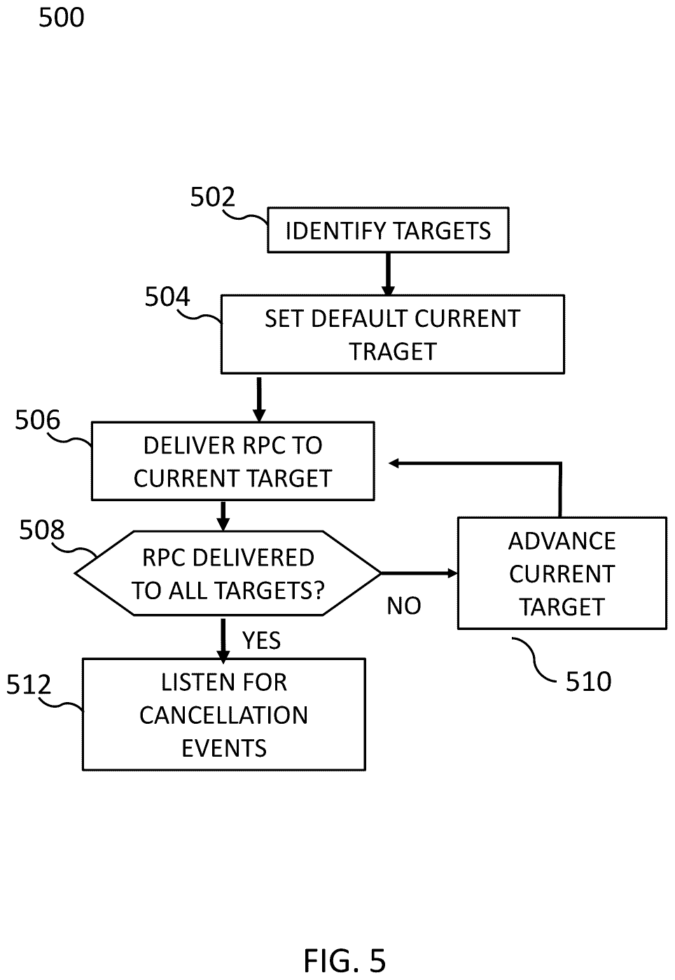

FIG. 5 is a flowchart of a method 500 of deploying a schedule for software updates for a set of NETCONF servers, in accordance with some embodiments. The method 500 is usable by an O-RAN system in order to help ensure that software deployment is more efficiently distributed to system components. By utilizing an assigning process, the method 500 helps to ensure that the software is more safely distributed to available system components. In some embodiments, the method 500 is able to be executed by the O-RAN system 100 (FIG. 1) or the O-RAN system 200 (FIG. 2). In some embodiments, the method 500 is able to be executed by an O-RAN system other than the O-RAN system 100 (FIG. 1) or the O-RAN system 200 (FIG. 2).

In operation 502, a set of targets is identified. In some embodiments, each target is a NETCONF server. In some embodiments, each target is an O-RU. In some embodiments, each target is to receive a software update or upgrade.

In operation 504, a default current target is identified. In some embodiments, a default current target is a first target in a set of targets.

In operation 506, an RPC is delivered to the current target. For example, an RPC is delivered to the first target in a set of targets or a first target in a deployment plan. In some embodiments, the RPC includes schedule information. For example, in some embodiments, the RPC includes a date and time to begin a software download, update, or installation. In some embodiments, the RPC is an RPC in FIG. 3. In some embodiments, the RPC is one of operations 312, 316, 318, 320, or 324 in FIG. 3.

In operation 508, a determination is made whether all targets in a set of targets have been received an RPC as described in operation 506. In some embodiments, if targets remain in the set of targets that have not yet received an RPC as in operation 506 or have not yet been assigned a date and time from a deployment plan, operation 510 is executed. In some embodiments, if all targets in the set of targets have received an RPC or have been scheduled to receive the software update according to the deployment plan, a listening process is started in operation 512.

In operation 510, the current target and RPC or deployment schedule date and time is advanced to a next target and next date and time. For example, a second target in a set of targets is selected as the current target after a first target. Further, for example, a second date and time is selected according to the deployment plan. In an example where each date and time are staggered by two milliseconds, a date and time that is two milliseconds after a first date and time assigned and scheduled to the first target is selected. An RPC is prepared according to the date and time selected from the deployment plan. For example, an RPC is prepared including schedule information for particular target. In some embodiments, operation 506 is repeated using the next target and next date and time determined in operation 510.

One of ordinary skill in the art would understand that additional operations are possible within method 500 in some embodiments. In some embodiments, an order of operations of the method 500 is changed. In some embodiments, at least one operation of the method 500 is omitted.

Utilizing the method 500 helps to efficiently utilize network resources. As a result, the network is more likely to function as intended following software deployment into the network in comparison with other approaches that fail to provide scheduling methods.

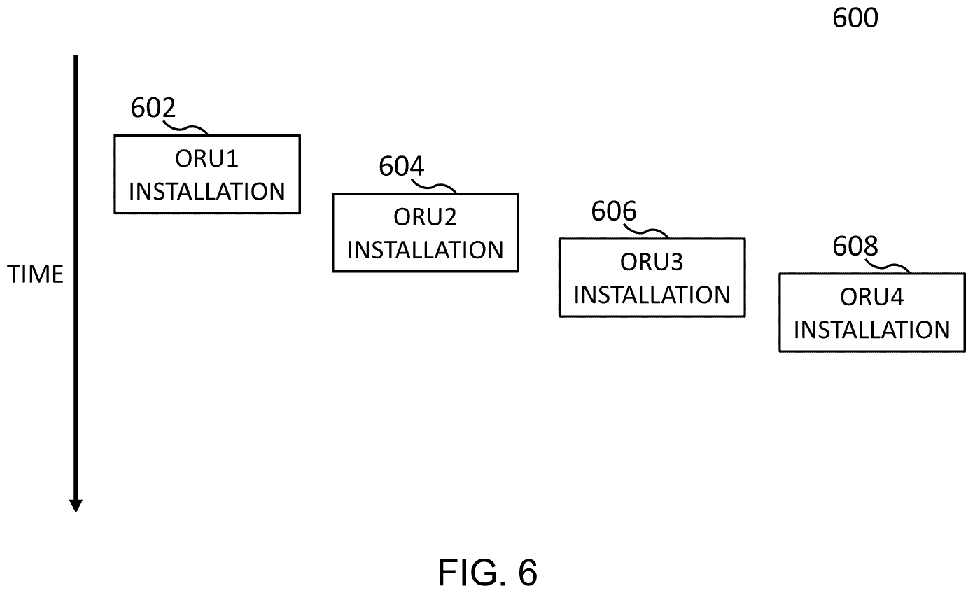

FIG. 6 is a sequence diagram of an installation process 600 using a schedule, in accordance with some embodiments. The process 600 is usable by an O-RAN system in order to help ensure that software deployment is more efficiently distributed to system components. By utilizing a schedule, the process 600 helps to ensure that the software is more safely distributed to available system components. In some embodiments, the process 600 is able to be executed by the O-RAN system 100 (FIG. 1) or the O-RAN system 200 (FIG. 2). In some embodiments, the process 600 is able to be executed by an O-RAN system other than the O-RAN system 100 (FIG. 1) or the O-RAN system 200 (FIG. 2).

A software update is scheduled to be delivered to each O-RU (NETCONF server) a set of four O-RUs, O-RU1, O-RU2, O-RU3, and O-RU4 according to embodiments herein. Each O-RU is assigned a date and time to receive the software update according to a deployment plan according to embodiments herein. In some embodiments, a deployment plan is determined by method 400 (FIG. 4). In some embodiments, a deployment plan is determined by a method other than method 400 (FIG. 4). Each O-RU is then scheduled to receive the software update, according to embodiments herein. In some embodiments, the scheduling is by method 500 (FIG. 5). In some embodiments, the scheduling is a method other than method 500 (FIG. 5).

In operation 602, a software update download and installation process is carried out at O-RU1. In some embodiments, the download and installation process is scheduled and carried out according to method 300 (FIG. 3). In some embodiments, the download and installation process is scheduled and carried out according to a method other than method 300 (FIG. 3). The software update process is scheduled for a first date and time.

In operation 604, a software update download and installation process is carried out at O-RU2. In some embodiments, the download and installation process is scheduled and carried out according to method 300 (FIG. 3). In some embodiments, the download and installation process is scheduled and carried out according to a method other than method 300 (FIG. 3). The software update process is scheduled for a second date and time after the first date and time.

In operation 606, a software update download and installation process is carried out at O-RU3. In some embodiments, the download and installation process is scheduled and carried out according to method 300 (FIG. 3). In some embodiments, the download and installation process is scheduled and carried out according to a method other than method 300 (FIG. 3). The software update process is scheduled for a third date and time after the second date and time.

In operation 608, a software update download and installation process is carried out at O-RU4. In some embodiments, the download and installation process is scheduled and carried out according to method 300 (FIG. 3). In some embodiments, the download and installation process is scheduled and carried out according to a method other than method 300 (FIG. 3). The software update process is scheduled for a fourth date and time after the third date and time.

A staggered arrangement of the respective dates and times at which the software updates are scheduled and delivered to O-RU1, O-RU2, O-RU3, and O-RU4 allows for more even distribution of resources.

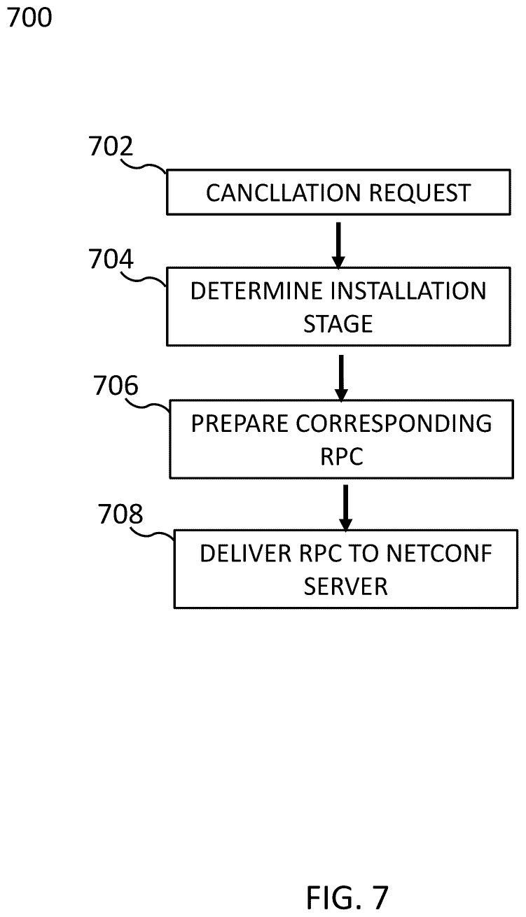

FIG. 7 is a flowchart of a method 700 of canceling software updates for a set of NETCONF servers, in accordance with some embodiments. The method 700 is usable by an O-RAN system in order to help ensure that software deployment is more efficiently distributed to system components. By utilizing a cancellation process, the method 700 helps to ensure that the software is more safely distributed to available system components. In some embodiments, the method 700 is able to be executed by the O-RAN system 100 (FIG. 1) or the O-RAN system 200 (FIG. 2). In some embodiments, the method 700 is able to be executed by an O-RAN system other than the O-RAN system 100 (FIG. 1) or the O-RAN system 200 (FIG. 2).

In operation 702, a cancellation request is received. In some embodiments, a cancellation request is received from a user. In some embodiments, a cancellation request is received programmatically. In some embodiments, a cancellation request is an automated request. In some embodiments, a cancellation request is delivered to a NETCONF server for which a software update download and installation process has been scheduled or started. In some embodiments, a cancellation request is propagated to multiple NETCONF servers in a deployment plan for which a software update has been scheduled. In some embodiments, a cancellation process is triggered by a software update download or installation failure event.

In operation 704, an installation stage of a software update download and installation process is determined. In some embodiments, a determination is made that a software update has been scheduled but not completed.

In operation 706, a cancellation RPC corresponding to the installation stage determined in operation 704 is prepared. For example, when an installation stage is determined to be a “DOWNLOAD” stage, such as shown in FIG. 3, a “CancelSchedule(DOWNLOAD)” RPC is prepared. For example, when an installation stage is determined to be a “INSTALL” stage, such as shown in FIG. 3, a “CancelSchedule(INSTALL)” RPC is prepared. For example, when an installation stage is determined to be a “ACTIVATE” stage, such as shown in FIG. 3, a “CancelSchedule(ACTIVATE)” RPC is prepared. For example, when an installation stage is determined to be a “RESET” stage, such as shown in FIG. 3, a “CancelSchedule(RESET)” RPC is prepared.

In operation, the cancellation RPC prepared in operation 706 is delivered to the respective NETCONF server.

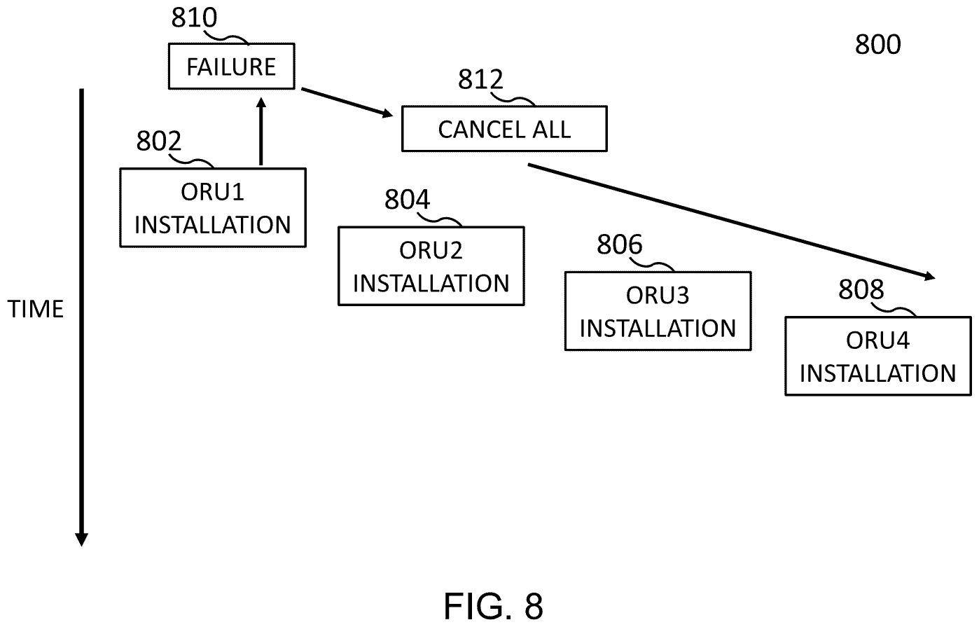

FIG. 8 is a sequence diagram of an installation cancellation process 800, in accordance with some embodiments. The process 800 is usable by an O-RAN system in order to help ensure that software deployment is more efficiently distributed to system components. By utilizing a schedule, the process 800 helps to ensure that the software is more safely distributed to available system components. In some embodiments, the process 800 is able to be executed by the O-RAN system 100 (FIG. 1) or the O-RAN system 200 (FIG. 2). In some embodiments, the process 800 is able to be executed by an O-RAN system other than the O-RAN system 100 (FIG. 1) or the O-RAN system 200 (FIG. 2).

A software update is scheduled to be delivered to each O-RU (NETCONF server) a set of four O-RUs, O-RU1, O-RU2, O-RU3, and O-RU4 according to embodiments herein. Each O-RU is assigned a date and time to receive the software update according to a deployment plan according to embodiments herein. In some embodiments, a deployment plan is determined by method 400 (FIG. 4). In some embodiments, a deployment plan is determined by a method other than method 400 (FIG. 4). Each O-RU is then scheduled to receive the software update, according to embodiments herein. In some embodiments, the scheduling is by method 500 (FIG. 5). In some embodiments, the scheduling is a method other than method 500 (FIG. 5).

In operation 802, a software update download and installation process is being, or scheduled to be, carried out at O-RU1. In some embodiments, the download and installation process is scheduled and carried out according to method 300 (FIG. 3). In some embodiments, the download and installation process is scheduled and carried out according to a method other than method 300 (FIG. 3). The software update process is scheduled for a first date and time.

In operation 804, a software update download and installation process is being, or scheduled to be, carried out at O-RU2. In some embodiments, the download and installation process is scheduled and carried out according to method 300 (FIG. 3). In some embodiments, the download and installation process is scheduled and carried out according to a method other than method 300 (FIG. 3). The software update process is scheduled for a second date and time after the first date and time.

In operation 806, a software update download and installation process is being, or scheduled to be, carried out at O-RU3. In some embodiments, the download and installation process is scheduled and carried out according to method 300 (FIG. 3). In some embodiments, the download and installation process is scheduled and carried out according to a method other than method 300 (FIG. 3). The software update process is scheduled for a third date and time after the second date and time.

In operation 808, a software update download and installation process is being, or scheduled to be, carried out at O-RU4. In some embodiments, the download and installation process is scheduled and carried out according to method 300 (FIG. 3). In some embodiments, the download and installation process is scheduled and carried out according to a method other than method 300 (FIG. 3). The software update process is scheduled for a fourth date and time after the third date and time.

A staggered arrangement of the respective dates and times at which the software updates are scheduled and delivered to O-RU1, O-RU2, O-RU3, and O-RU4 allows for more even distribution of resources.

In operation 810, a software update failure event at ORU1 is identified or received. In some embodiments, a failure event is received from a fault detection system or process. In some embodiments, a failure event is received programmatically. In some embodiments, a failure event is delivered to a NETCONF server for which a software update download and installation process has been scheduled or started. In some embodiments, a failure event is propagated to multiple NETCONF servers in a deployment plan for which a software update has been scheduled. In some embodiments, a cancellation process is triggered by a software update download or installation failure event.

In operation 812, the failure event at ORU1 is propagated to ORU2, ORU3, and ORU4. In some embodiments, a failure event is propagated to downstream software update download and installation processes or software update download and installation processes that are dependent on the upstream software update download and installation process. In some embodiments, a determination is made that a software update has been scheduled but not completed at each downstream software update download and installation process.

In operation 812, a cancellation RPC corresponding to an installation stage is prepared, according to embodiments herein, for each of the ORU installations downstream from ORU1, including ORU2, ORU3, and ORU4. For example, when an installation stage is determined to be a “DOWNLOAD” stage, such as shown in FIG. 3, a “CancelSchedule(DOWNLOAD)” RPC is prepared. For example, when an installation stage is determined to be a “INSTALL” stage, such as shown in FIG. 3, a “CancelSchedule(INSTALL)” RPC is prepared. For example, when an installation stage is determined to be a “ACTIVATE” stage, such as shown in FIG. 3, a “CancelSchedule(ACTIVATE)” RPC is prepared. For example, when an installation stage is determined to be a “RESET” stage, such as shown in FIG. 3, a “CancelSchedule(RESET)” RPC is prepared. Each cancellation RPC is delivered to the respective NETCONF server.

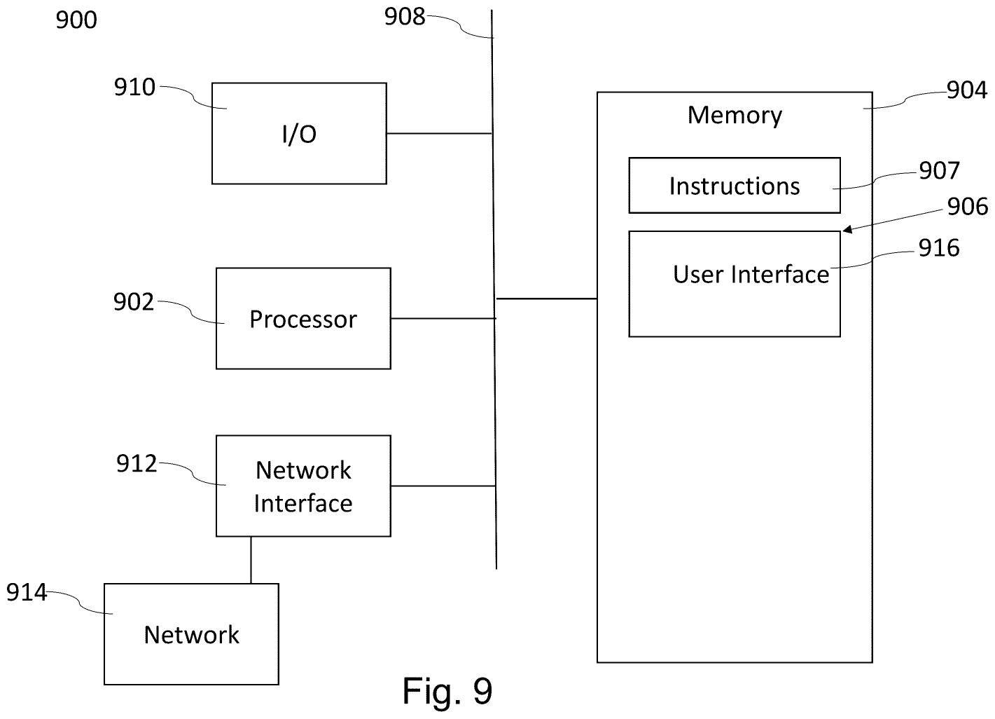

FIG. 9 is a block diagram of computer architecture 900 in accordance with some embodiments.

Computer architecture 900 includes a hardware processor 902 and a non-transitory, computer readable storage medium 904 encoded with, i.e., storing, the computer program code 906, i.e., a set of executable instructions. Computer readable storage medium 904 is also encoded with instructions 907 for interfacing with external devices. The processor 902 is electrically coupled to the computer readable storage medium 904 via a bus 908. The processor 902 is also electrically coupled to an I/O interface 910 by bus 908. A network interface 912 is also electrically connected to the processor 902 via bus 908. Network interface 912 is connected to a network 914, so that processor 902 and computer readable storage medium 904 are capable of connecting to external elements via network 914. The processor 902 is configured to execute the computer program code 906 encoded in the computer readable storage medium 904 in order to cause computer architecture 900 to be usable for performing a portion or all of the operations as described herein.

In some embodiments, the processor 902 is a central processing unit (CPU), a multi-processor, a distributed processing system, an application specific integrated circuit (ASIC), and/or a suitable processing unit.

In some embodiments, the computer readable storage medium 904 is an electronic, magnetic, optical, electromagnetic, infrared, and/or a semiconductor system (or apparatus or device). For example, the computer readable storage medium 904 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 904 includes a compact disk-read only memory (CD-ROM), a compact disk-read/write (CD-R/W), and/or a digital video disc (DVD).

In some embodiments, the storage medium 904 stores the computer program code 906 configured to cause computer architecture 900 to perform a portion or all of the operations as described herein. In some embodiments, the storage medium 904 also stores information needed for performing a portion or all of the operations as described herein as well as information generated during performing a portion or all of the operations as described herein, such as a user interface parameter 916.

In some embodiments, the storage medium 904 stores instructions 907 for interfacing with external devices. The instructions 907 enable processor 902 to generate instructions readable by the external devices to effectively implement a portion or all of the operations as described herein.

Computer architecture 900 includes I/O interface 910. I/O interface 910 is coupled to external circuitry. In some embodiments, I/O interface 910 includes a keyboard, keypad, mouse, trackball, trackpad, and/or cursor direction keys for communicating information and commands to processor 902.

Computer architecture 900 also includes network interface 912 coupled to the processor 902. Network interface 912 allows computer architecture 900 to communicate with network 914, to which one or more other computer systems are connected. Network interface 912 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described herein, and information are exchanged between different computer architecture 900 via network 914.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

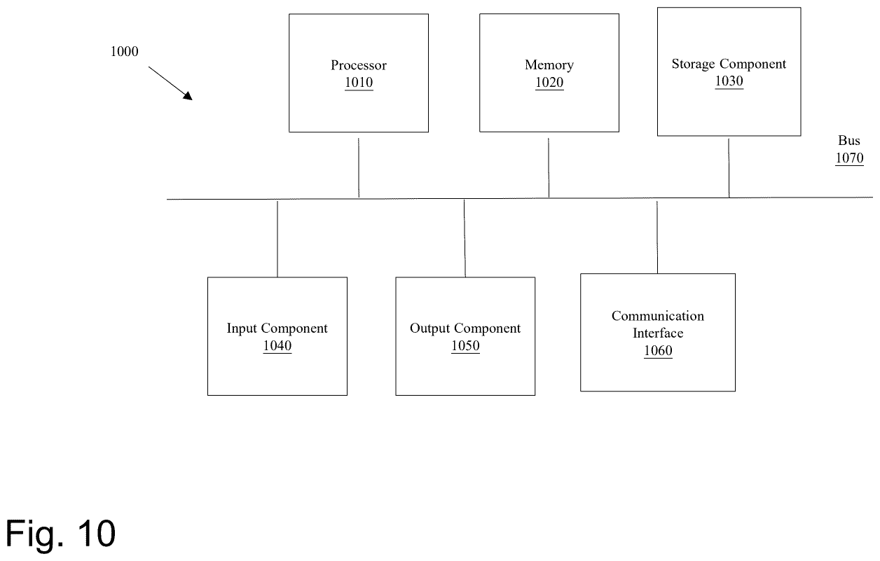

FIG. 10 illustrates an embodiment of an alternative computer architecture in accordance with some embodiments. As shown in FIG. 10, the device 1000 includes processor 1010, a memory 1020, a storage component 1030, an input component 1040, an output component 1050, a communication interface 1060, and a bus 1070.

The processor 1010, as used herein, means any type of computational circuit that may comprise hardware elements and software elements. The processor 1010 may be embodied as a multi-core processor, a single core processor, or a combination of one or more multi-core processors and/or one or more single core processors, a distributed processing system, or the like. The processor 1010 may be a Central Processing Unit (CPU), a graphics processing unit (GPU), an accelerated processing unit (APU), an application-specific integrated circuit (ASIC), or another type of processing component.

Memory 1020 includes a non-transitory computer readable medium. Memory 1020 includes a random-access memory (RAM), a read only memory (ROM), and/or another type of dynamic or static storage device (e.g., a flash memory, a magnetic memory, and/or an optical memory) that stores information and/or instructions for use by processor 1010. The memory 1020 comprises machine-readable instructions which are executable by the processor 1010. These machine-readable instructions when executed by the processor 1010 cause the processor 1010 to perform one or more method steps of an embodiment described above.

Storage component 1030 stores information and/or software related to the operation and use of the device 1000. For example, storage component 1030 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1040 is configured to receive information, such as user input. For example, the input component 1040 may include, but not be limited to, a touch screen display, a keyboard, a keypad, a mouse, a button, a switch, and/or a microphone. Additionally, or alternatively, the input component 1040 may include a sensor for sensing information (e.g., a global positioning system (GPS), an accelerometer, a gyroscope, and/or an actuator).

Output component 1050 is configured to provide output information from the device 1000. For example, the output component 1050 may be, but not limited to, a display, a speaker, an instruction device to an external device, and/or one or more light-emitting diodes (LEDs).

Communication interface 1060 is an interface that provides a communication connection to other devices, such as external devices and internal devices. The connection by the communication interface 1060 can be a wired connection, a wireless connection, or a combination of wired and wireless connections, and can be a direct connection or an indirect connection via a communication network that exists between the device 1000 and other devices. In other words, the standard of the communication interface 1060 is not limited.

The bus 1070 acts as an interconnect between the processor 1010, the memory 1020, the storage component 1030, the input component 1040, the output component 1050, and the communication interface 1060 of the device 1000. The bus 1070 may include a wired interconnection or a wireless interconnection.

The number and arrangement of components shown in FIG. % are provided as an example. In practice, device 1000 may include additional components, fewer components, different components, or differently arranged components than those shown in FIG. %. Additionally, or alternatively, a set of components (e.g., one or more components) of device 1000 may perform one or more functions described as being performed by another set of components of device 1000. Further, one or more method steps described in any of the embodiments may be performed utilizing a plurality of devices 1000 in communication with one another.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the disclosure.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

### Supplemental Note 1

A system includes a non-transitory computer readable medium configured to store instructions thereon. The system further includes a processor connected to the non-transitory computer readable medium. The processor is configured to execute the instructions for establishing a NETCONF session. The processor is configured to execute the instructions for receiving a first instruction for a software update for a first NETCONF server, wherein the first instruction includes configuration information comprising schedule information. The processor is configured to execute the instructions for scheduling installation of the software update for the first NETCONF server based on the schedule information. The processor is configured to execute the instructions for and triggering, in response to the scheduling, a first installation cascade for the software update by the first NETCONF server based on the schedule information.

### Supplemental Note 2

In some embodiments, the processor of Supplemental Note 1 is further configured to execute the instructions for: receiving the first instruction for the software update for the first NETCONF server, wherein the first instruction includes configuration information comprising schedule information specifying a first date and a first time in a YANG file.

### Supplemental Note 3

In some embodiments, the processor of any of Supplemental Notes 1 and 2 is further configured to execute the instructions for: triggering, in response to the scheduling, the first installation cascade for the software update by the first NETCONF server based on the schedule information by waiting until the first date and first time to begin the first installation cascade.

### Supplemental Note 4

In some embodiments, the processor of any of Supplemental Notes 1-3, wherein the scheduling installation of the software update for the first NETCONF server comprises sending, from the first NETCONF server to a NETCONF client, a first message that the software update has been scheduled.

### Supplemental Note 5

In some embodiments, the processor of any of Supplemental Notes 1-4 is further configured to execute the instructions for: triggering, in response to the scheduling, the first installation cascade, wherein the first installation cascade comprises downloading, installing, or activating the software update at the first NETCONF server.

### Supplemental Note 6

In some embodiments, the processor any of Supplemental Notes 1-5 is further configured to execute the instructions for: receiving a second instruction to cancel the software update for the first NETCONF server.

### Supplemental Note 7

In some embodiments, the processor any of Supplemental Notes 1-7 is further configured to execute the instructions for: interrupting the installation cascade in response to the receiving the second instruction to cancel the software update for the first NETCONF server.

### Supplemental Note 8

A method includes establishing a NETCONF session. The method further includes receiving a first instruction for a software update for a first NETCONF server, wherein the first instruction includes configuration information comprising schedule information. The method further includes scheduling installation of the software update for the first NETCONF server based on the schedule information. The method further includes and triggering, in response to the scheduling, a first installation cascade for the software update by the first NETCONF server based on the schedule information.

### Supplemental Note 9

The method of Supplemental Note 8 further comprising: receiving the first instruction for the software update for the first NETCONF server, wherein the first instruction includes configuration information comprising schedule information specifying a first date and a first time in a YANG file.

### Supplemental Note 10

The method of Supplemental Note 8 or 9 further comprising: triggering, in response to the scheduling, the first installation cascade for the software update by the first NETCONF server based on the schedule information by waiting until the first date and first time to begin the first installation cascade.

### Supplemental Note 11

The method of any of Supplemental Notes 8-10, wherein the scheduling installation of the software update for the first NETCONF server comprises sending, from the first NETCONF server to a NETCONF client, a first message that the software update has been scheduled.

### Supplemental Note 12

The method of any of Supplemental Notes 8-11, further comprising: triggering, in response to the scheduling, the first installation cascade, wherein the first installation cascade comprises downloading, installing, or activating the software update at the first NETCONF server.

### Supplemental Note 13

The method of any of Supplemental Notes 8-12, further comprising: receiving a second instruction to cancel the software update for the first NETCONF server.

### Supplemental Note 14

The method of any of Supplemental Notes 8-13, further comprising: interrupting the installation cascade in response to the receiving the second instruction to cancel the software update for the first NETCONF server.

### Supplemental Note 15

A non-transitory computer readable medium configured to store instructions thereon. The instructions are configured to cause a processor to perform operations comprising establishing a NETCONF session. The instructions are configured to cause a processor to perform operations comprising receiving a first instruction for a software update for a first NETCONF server, wherein the first instruction includes configuration information comprising schedule information. The instructions are configured to cause a processor to perform operations comprising scheduling installation of the software update for the first NETCONF server based on the schedule information. The instructions are configured to cause a processor to perform operations comprising and triggering, in response to the scheduling, a first installation cascade for the software update by the first NETCONF server based on the schedule information.

### Supplemental Note 16

The non-transitory computer readable medium of Supplemental Note 15, wherein the instructions are configured to cause a processor to perform operations comprising: receiving the first instruction for the software update for the first NETCONF server, wherein the first instruction includes configuration information comprising schedule information specifying a first date and a first time in a YANG file.

### Supplemental Note 17

The non-transitory computer readable medium of any of Supplement Note 15 or 16, wherein the instructions are configured to cause a processor to perform operations comprising: triggering, in response to the scheduling, the first installation cascade for the software update by the first NETCONF server based on the schedule information by waiting until the first date and first time to begin the first installation cascade.

### Supplemental Note 18

The non-transitory computer readable medium of any of Supplemental Notes 15-17, wherein the scheduling installation of the software update for the first NETCONF server comprises sending, from the first NETCONF server to a NETCONF client, a first message that the software update has been scheduled.

### Supplemental Note 19

The non-transitory computer readable medium of any of Supplemental Notes 15-18, wherein the instructions are configured to cause a processor to perform operations comprising: triggering, in response to the scheduling, the first installation cascade, wherein the first installation cascade comprises downloading, installing, or activating the software update at the first NETCONF server.

### Supplemental Note 20

The non-transitory computer readable medium of any of Supplemental Notes 15-19, wherein the instructions are configured to cause a processor to perform operations comprising: receiving a second instruction to cancel the software update for the first NETCONF server; and interrupting the installation cascade in response to the receiving the second instruction to cancel the software update for the first NETCONF server.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for scheduling updates of a server, the system configured to:
establish a NETCONF session;
receive a first instruction for a software update for a first NETCONF server, wherein the first instruction includes configuration information comprising schedule information;
schedule installation of the software update for the first NETCONF server based on the schedule information; and
trigger, in response to the scheduling, a first installation cascade for the software update by the first NETCONF server based on the schedule information.

2. The system of claim 1, further configured to execute the instructions for:
receiving the first instruction for the software update for the first NETCONF server, wherein the first instruction includes configuration information comprising schedule information specifying a first date and a first time in a YANG file.

3. The system of claim 2, further configured to execute the instructions for:
triggering, in response to the scheduling, the first installation cascade for the software update by the first NETCONF server based on the schedule information by waiting until the first date and first time to begin the first installation cascade.

4. The system of claim 1, wherein the scheduling installation of the software update for the first NETCONF server comprises sending, from the first NETCONF server to a NETCONF client, a first message that the software update has been scheduled.

5. The system of claim 1, further configured to execute the instructions for:
triggering, in response to the scheduling, the first installation cascade, wherein the first installation cascade comprises downloading, installing, or activating the software update at the first NETCONF server.

6. The system of claim 5, further configured to execute the instructions for:
receiving a second instruction to cancel the software update for the first NETCONF server.

7. The system of claim 6, further configured to execute the instructions for:
interrupting the installation cascade in response to the receiving the second instruction to cancel the software update for the first NETCONF server.

8. A method, the method comprising:
establishing a NETCONF session;
receiving a first instruction for a software update for a first NETCONF server, wherein the first instruction includes configuration information comprising schedule information;
scheduling installation of the software update for the first NETCONF server based on the schedule information; and
triggering, in response to the scheduling, a first installation cascade for the software update by the first NETCONF server based on the schedule information.

9. The method of claim 8, further comprising:
receiving the first instruction for the software update for the first NETCONF server, wherein the first instruction includes configuration information comprising schedule information specifying a first date and a first time in a YANG file.

10. The method of claim 9, further comprising:
triggering, in response to the scheduling, the first installation cascade for the software update by the first NETCONF server based on the schedule information by waiting until the first date and first time to begin the first installation cascade.

11. The method of clam 8, wherein the scheduling installation of the software update for the first NETCONF server comprises sending, from the first NETCONF server to a NETCONF client, a first message that the software update has been scheduled.

12. The method of claim 8, further comprising:
triggering, in response to the scheduling, the first installation cascade, wherein the first installation cascade comprises downloading, installing, or activating the software update at the first NETCONF server.

13. The method of claim 12, further comprising:
receiving a second instruction to cancel the software update for the first NETCONF server.

14. The method of claim 13, further comprising:
interrupting the installation cascade in response to the receiving the second instruction to cancel the software update for the first NETCONF server.

15. A non-transitory computer-readable media having computer-readable instructions stored thereon, which in response to being executed causes a system to schedule updates of a server to perform operations comprising:
establishing a NETCONF session;
receiving a first instruction for a software update for a first NETCONF server, wherein the first instruction includes configuration information comprising schedule information;
scheduling installation of the software update for the first NETCONF server based on the schedule information; and
triggering, in response to the scheduling, a first installation cascade for the software update by the first NETCONF server based on the schedule information.

16. The non-transitory computer readable medium of claim 15, the operations further comprising:
receiving the first instruction for the software update for the first NETCONF server, wherein the first instruction includes configuration information comprising schedule information specifying a first date and a first time in a YANG file.

17. The non-transitory computer readable medium of claim 16, the operations further comprising:
triggering, in response to the scheduling, the first installation cascade for the software update by the first NETCONF server based on the schedule information by waiting until the first date and first time to begin the first installation cascade.

18. The non-transitory computer readable medium of clam 15, wherein the scheduling installation of the software update for the first NETCONF server comprises sending, from the first NETCONF server to a NETCONF client, a first message that the software update has been scheduled.

19. The non-transitory computer readable medium of claim 15, the operations further comprising:
triggering, in response to the scheduling, the first installation cascade, wherein the first installation cascade comprises downloading, installing, or activating the software update at the first NETCONF server.

20. The non-transitory computer readable medium of claim 18, the operations further comprising:
receiving a second instruction to cancel the software update for the first NETCONF server; and
interrupting the installation cascade in response to the receiving the second instruction to cancel the software update for the first NETCONF server.
